(19) United States
(12) Patent Application Publication
(10) Pub. No.: US 2016/0335447 A1
(43) Pub. Date: Nov. 17, 2016

(54) SECURE ENTERPRISE CDN FRAMEWORK

(71) Applicant: ALCATEL-LUCENT USA, INC., Murray Hill, NJ (US)

(72) Inventors: Katherine H. GUO, Scotch Plains, NJ (US); Krishan K SABNANI, Westfield, NJ (US)

(21) Appl. No.: 14/713,525

(22) Filed: May 15, 2015

(51) Int. Cl. G06F 21/62; G06F 21/60; H04L 29/06

(52) U.S. Cl. CPC G06F 21/6218; H04L 63/0272; G06F 21/602

(57) ABSTRACT

Various embodiments relate to a method, network node, and non-transitory machine-readable storage medium including the following: providing access to an enterprise file system to end user devices via a virtual private network (VPN); encrypting at least a portion of an enterprise file system to produce an encrypted file system, wherein an encrypted file from the encrypted file system is capable of being decrypted using a decryption key; transmitting the encrypted file system to a content distribution network (CDN) server for storage and access, wherein the CDN server is located outside the VPN; and transmitting the decryption key to an end user device via the VPN.

### TECHNICAL FIELD

Various exemplary embodiments disclosed herein relate generally to computer networking and, more specifically but not exclusively, to remote access to enterprise data.

### BACKGROUND

Content distribution networks (CDNs) are an integral part of the Internet today. A CDN is a large distributed system of servers deployed in multiple data centers across the Internet. A large fraction of the Internet content today are distributed from the origin server of the content provider to these CDN servers before reaching the end-users. CDNs aim to distribute content with high performance and high availability because of their ability to offload traffic directly from the origin server infrastructure and to serve content from CDN servers located closer to the end-users than the origin server.

Enterprise communication today is based on virtual private networks (“VPNs”). VPNs are used to connect data centers and gateways of individual enterprise sites as well as to provide remote user access to data centers and gateways to individual sites. In other words, the enterprise infrastructure consisting of data centers and individual sites rely on VPNs running over public service provider networks. Within this infrastructure, enterprise content can be distributed and replicated to distributed servers located in multiple data centers and sites just as with any traditional CDN.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a non-transitory machine-readable storage medium encoded with instructions for execution by an enterprise server, the non-transitory machine-readable storage medium including: instructions for providing access to an enterprise file system to end user devices via a virtual private network (VPN); instructions for encrypting at least a portion of an enterprise file system to produce an encrypted file system, wherein an encrypted file from the encrypted file system is capable of being decrypted using a decryption key; instructions for transmitting the encrypted file system to a content distribution network (CDN) server for storage and access, wherein the CDN server is located outside the VPN; and instructions for transmitting the decryption key to an end user device via the VPN.

Various embodiments described herein relate to a an enterprise server including: a network interface capable of communication over an open network and over a virtual private network (VPN); a memory; and a processor in communication with the network interface and the memory, the processor configured to: encrypt at least a portion of an enterprise file system accessible to the enterprise server to produce an encrypted file system, wherein an encrypted file from the encrypted file system is capable of being decrypted using a decryption key; transmit the encrypted file system to a content distribution network (CDN) server for storage and access, wherein the CDN server is located outside the VPN; and transmit the decryption key to an end user device via the VPN.

Various embodiments described herein relate to a method performed by an enterprise server, the method including: providing access to an enterprise file system to end user devices via a virtual private network (VPN); encrypting at least a portion of an enterprise file system to produce an encrypted file system, wherein an encrypted file from the encrypted file system is capable of being decrypted using a decryption key; transmitting the encrypted file system to a content distribution network (CDN) server for storage and access, wherein the CDN server is located outside the VPN; and transmitting the decryption key to an end user device via the VPN.

Various embodiments additionally include: periodically executing the instructions for encrypting and the instructions for transmitting the encrypted file system, whereby the decryption key changes periodically.

Various embodiments additionally include instructions for applying a filename transformation to at least one of the enterprise file system and the encrypted file system, wherein at least one file in the encrypted file system has a file name that is different from a file name of a corresponding file in the enterprise file system.

Various embodiments additionally include transmitting an identification of the filename transformation to the end user device via the VPN.

Various embodiments additionally include: segmenting at least one of a file of the enterprise file system and an encrypted file of the encrypted file system into a plurality of data blocks.

Various embodiments are described wherein the step of transmitting the encrypted file system includes transmitting a plurality of encrypted data blocks to the CDN server, the method further including: generating at least one file map for a file of the encrypted file system, wherein the file map identifies a sequence of blocks from the plurality of encrypted data blocks; and transmitting the at least one file map to the end user device via the VPN.

Various embodiments are described wherein the file map identifies a sequence of blocks by specifying a list of block identifiers; and the step encrypting at least a portion of an enterprise file system include: generating the plurality of encrypted blocks, including: segmenting at least one file of the enterprise file system into multiple data blocks; and generating multiple block identifiers by applying a hash function to the multiple data blocks respectively, whereby the multiple block identifiers are used by a file map to identify the multiple blocks as being associated with the at least one file.

### BRIEF DESCRIPTION OF THE DRAWINGS

In order to better understand various exemplary embodiments, reference is made to the accompanying drawings, wherein:

FIG. 1 illustrates an example of an environment for implementing a secure enterprise CDN framework;

FIG. 2 illustrates an example of a hardware device for participating in a secure enterprise CDN framework;

FIG. 3 illustrates a first example method for storing and accessing secure enterprise data on a CDN server;

FIG. 4 illustrates a second example method for storing and accessing secure enterprise data on a CDN server; and

FIG. 5 illustrates a third example method for storing and accessing secure enterprise data on a CDN server.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

In remote access enterprise sites, the number of data centers and sites for each enterprise is limited based on the geographical locations of the sites. This means users located far away from enterprise data centers or sites suffer from large network distance when accessing enterprise content. With the ever increasing mobile workforce that relies on VPN access, it would be desirable to improve enterprise users experience with enterprise network regardless of the location of end users.

Accordingly, various embodiments herein utilize content distribution networks to duplicate enterprise data to CDN servers that may be closer than the enterprise site to the end user device wishing to access enterprise data. To protect the confidentiality of the enterprise data, the enterprise encrypts the data or employs other obfuscation techniques prior to storing of the data on the CDN servers. The enterprise servers may then coordinate with end user devices over the VPN to enable the end user devices to access the data from the closer CDN servers.

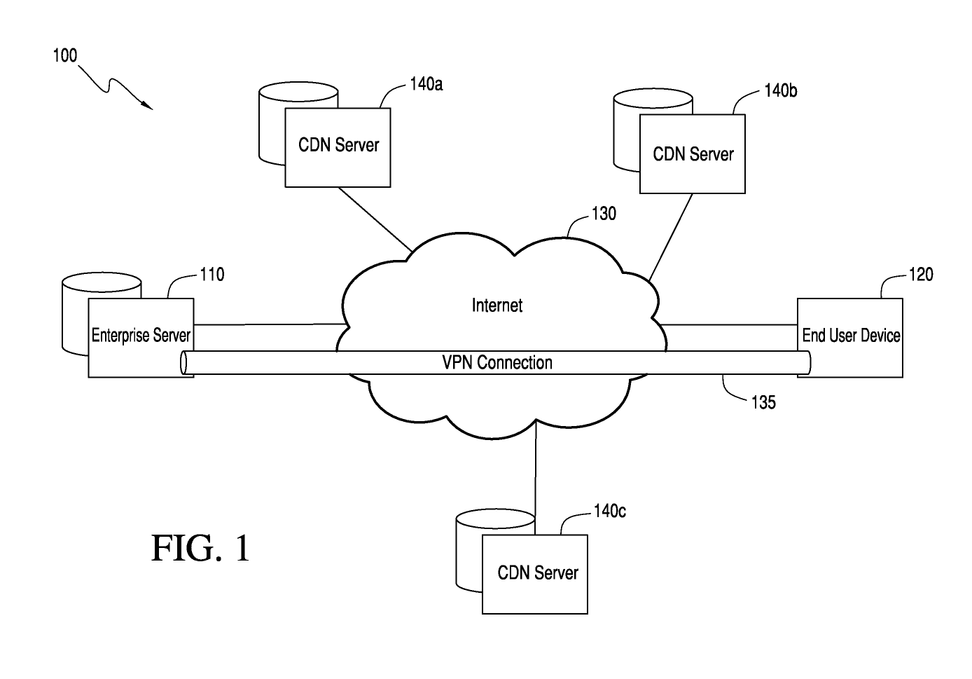

FIG. 1 illustrates an example of an environment 100 for implementing a secure enterprise CDN framework. As shown, the environment includes an enterprise server 110 and an end user device 120 in communication with each other via a network such as the Internet 130. The enterprise server 110 may be virtually any device capable of serving information to an end user device 120 such as, for example, a personal computer, server, or blade. Similarly, the end user device 120 may be virtually any device capable of requesting, receiving, and presenting such data to a user. For example, the end user device 120 may be a personal computer, laptop computer, tablet, wristwatch, or mobile phone.

As shown, the end user device 120 communicates with the enterprise server 110 via a virtual private network (VPN) connection 135. In various embodiments, the VPN connection 135 may be an encrypted or otherwise secure connection to the enterprise server 110 (and potentially other devices at an enterprise site) that allows the end user device 120 to be seen as a locally-connected device on the enterprise network in spite of the end user device being remotely located. In some embodiments, the enterprise server 110 also provides access to an enterprise file system via the VPN connection 135, thereby allowing the end user device to traverse a directory structure to locate and request data files to be served.

As will be understood, various environments 100 may include multiple enterprise servers 110 or multiple end user devices 120. For example, hundreds or thousands of end user devices may be provided with VPN connections to one or more enterprise servers located at a central enterprise site. Such an arrangement, however, may create inefficiencies. For example, the further from the enterprise site an end user device is located, the more network delay is experiences when browsing a file system and requesting service of files. Additionally, with a centralized approach to file service, periods of high activity may overload the server and thereby introduce additional delay to serving requested files.

To address these limitations, various embodiments described herein may duplicate the enterprise file system (or portions thereof) among one or more content delivery network (CDN) servers 140 a,b,c. The CDN servers 140 a,b,c may be operated by a third party and may be distributed geographically across multiple different data centers. Thus, when requesting a file from the enterprise file system, the end user device 120 may, instead of requesting directly from the enterprise server 110, may locate the nearest CDN server 140b to retrieve the file. As such, the network delay experienced is reduced and the total load is distributed among the CDN servers 140 a,b,c. As noted, however, the CDN servers 140 a,b,c may be operated by third parties and, as such, may not be connected to the VPN; instead, the end user device 120 may request content from the CDN server 140b as open Internet traffic. As such, where the data was previously presented in a more secure fashion via the VPN, it is now more likely that the data may be compromised in transit or by the operator of the CDN itself. Accordingly, various approaches for providing data secrecy through data and metadata obfuscation are described herein below.

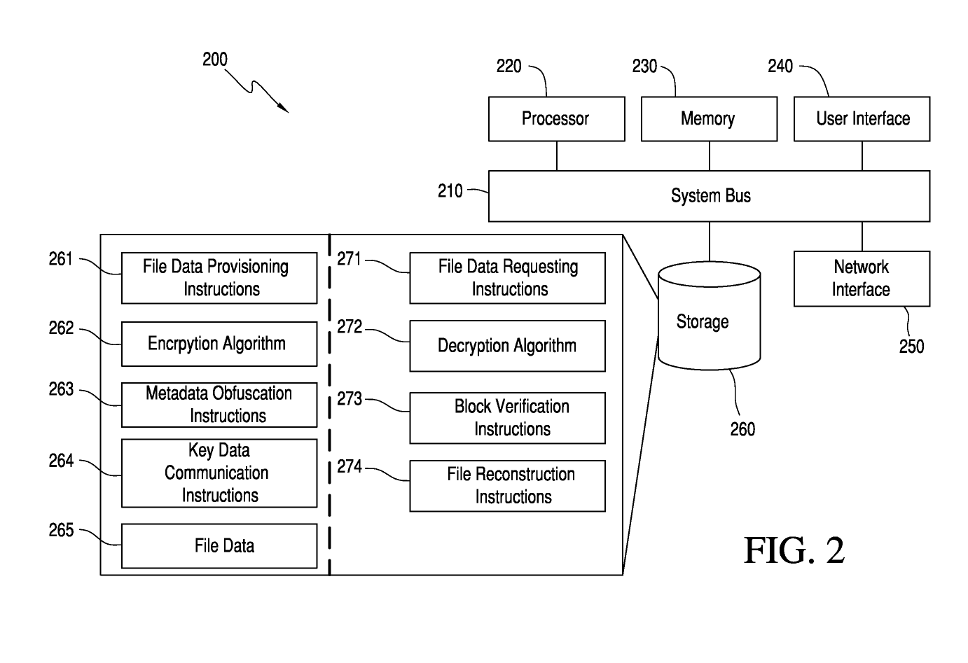

FIG. 2 illustrates an example of a hardware device 200 for participating in a secure enterprise CDN framework. The exemplary hardware 200 may correspond to the enterprise server 110 or end-user device 120 of FIG. 1. As shown, the device 200 includes a processor 220, memory 230, user interface 240, network interface 250, and storage 260 interconnected via one or more system buses 210. It will be understood that FIG. 2 constitutes, in some respects, an abstraction and that the actual organization of the components of the device 200 may be more complex than illustrated.

The processor 220 may be any hardware device capable of executing instructions stored in memory 230 or storage 260 or otherwise processing data. As such, the processor may include a microprocessor, field programmable gate array (FPGA), application-specific integrated circuit (ASIC), or other similar devices.

The memory 230 may include various memories such as, for example L1, L2, or L3 cache or system memory. As such, the memory 230 may include static random access memory (SRAM), dynamic RAM (DRAM), flash memory, read only memory (ROM), or other similar memory devices.

The user interface 240 may include one or more devices for enabling communication with a user such as an administrator. For example, the user interface 240 may include a display, a mouse, and a keyboard for receiving user commands. In some embodiments, the user interface 240 may include a command line interface or graphical user interface that may be presented to a remote terminal via the network interface 250.

The network interface 250 may include one or more devices for enabling communication with other hardware devices. For example, the network interface 250 may include a network interface card (NIC) configured to communicate according to the Ethernet protocol. Additionally, the network interface 250 may implement a TCP/IP stack for communication according to the TCP/IP protocols. Various alternative or additional hardware or configurations for the network interface 250 will be apparent.

The storage 260 may include one or more machine-readable storage media such as read-only memory (ROM), random-access memory (RAM), magnetic disk storage media, optical storage media, flash-memory devices, or similar storage media. In various embodiments, the storage 260 may store instructions for execution by the processor 220 or data upon with the processor 220 may operate.

For example, where the device 200 is an enterprise server, the storage 260 may include file data 265 to be served to end user devices and file data provisioning instructions 261 for transmitting the file data 265 to one or more CDN servers. To keep data and metadata secret from the CDN operator, the storage 260 may also include an encryption algorithm 262 to encrypt the file data 265 or metadata obfuscation instructions 263 to perform various transformations to protect against CDN discovery of metadata such as file system structure, file names, file sizes, etc. To enable an end user device to access and utilize file data 265 in spite of operations performed by the encryption algorithm 262 or metadata obfuscation instructions 263, the storage 264 also includes key data communication instructions 264 for transmitting key data to the end user devices. As used herein, the term “key data” will be understood to refer to any information that may be used to reverse operations performed to obscure data or metadata such as, for example, cryptographic keys, file system transformation functions, block-to-file mappings, block id generation functions, etc.

Where the device 200 is used to implement an end user device, the storage may include file data requesting instructions 271 for requesting that file data be provided by an external server. The file data requesting instructions 271 may identify a CDN server or enterprise server for processing a file request based on, for example, reported load or geographic proximity. In some embodiments, the file data requesting instructions 271 may be performed at the request of a user via the user interface 240 or automatically by request of another application that wishes to access remote data. The file data requesting instructions 271 may also include instructions for obscuring or unobscuring a file system structure to locate a desired file, an example of which will be described in greater detail below. Depending on the data or metadata obscuring techniques employed by the enterprise to data hosted by the CDN servers, the storage may also include a decryption algorithm 272, block verification instructions 273, or file reconstruction instructions 274 to be used in returning the data to its original form, examples of which will be explained in greater detail below.

It will be apparent that various information described as stored in the storage 260 may be additionally or alternatively stored in the memory 230. In this respect, the memory 230 may also be considered to constitute a “storage device” and the storage 260 may be considered a “memory.” Various other arrangements will be apparent. Further, the memory 230 and storage 260 may both be considered to be “non-transitory machine-readable media.” As used herein, the term “non-transitory” will be understood to exclude transitory signals but to include all forms of storage, including both volatile and non-volatile memories.

While the host device 200 is shown as including one of each described component, the various components may be duplicated in various embodiments. For example, the processor 220 may include multiple microprocessors that are configured to independently execute the methods described herein or are configured to perform steps or subroutines of the methods described herein such that the multiple processors cooperate to achieve the functionality described herein. Further, where the device 200 is implemented in a cloud computing system, the various hardware components may belong to separate physical systems. For example, the processor 220 may include a first processor in a first server and a second processor in a second server.

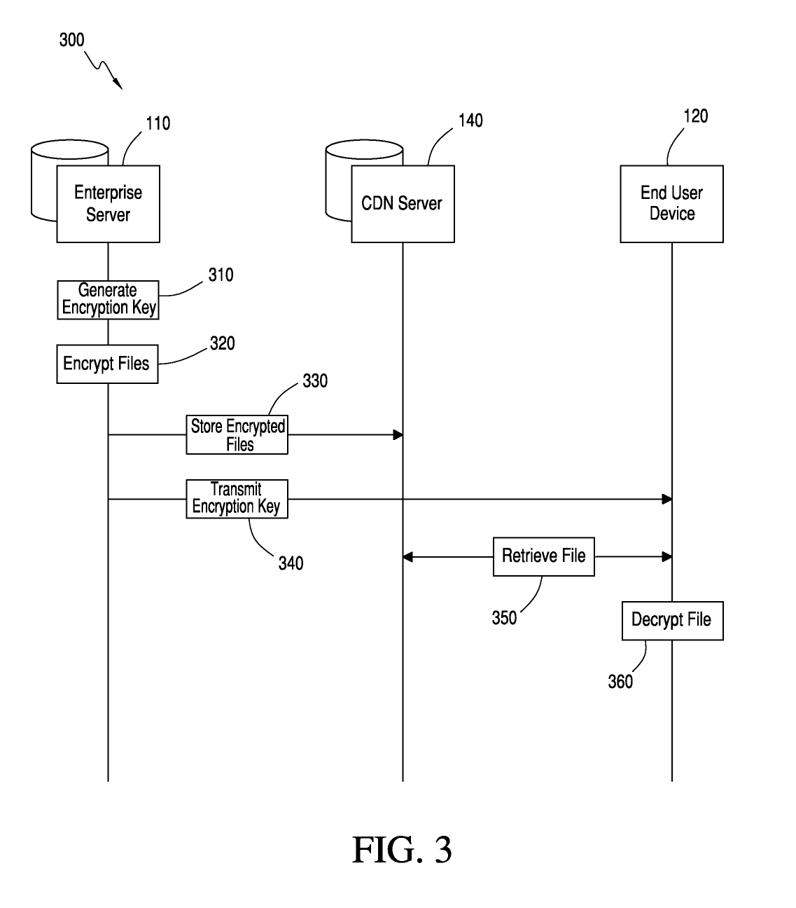

As noted above, an enterprise server may employ various techniques to obscure data and metadata which would otherwise be revealed to the CDN provider when the file system is copied to the CDN server. For example, to protect the data itself, the data may be encrypted before being copied to the CDN server. Virtually any encryption method may be utilized, including both symmetric and asymmetric encryption algorithms. According to some example embodiments, the data may be encrypted using the AES or RSA encryption standards. FIG. 3 illustrates a first example method 300 for storing and accessing secure enterprise data on a CDN server. As will be shown, this first example utilizes data encryption to secure the data itself when stored on a CDN server that is external to the enterprise VPN. The method 300 involves three devices: an enterprise server 110, an end user device 120, and a CDN server 140. It will be apparent that, in some respects, the method 300 may constitute a simplification; for example, additional enterprise servers 110, end user devices 120, or CDN servers 140 may participate in the method 300. Various modifications will be apparent. The method 300 (and other example methods described herein) also includes various inter-device communications which may be implemented according to any appropriate protocols such as, for example, standard HTTP requests. As will be understood, when the data being transferred is already encrypted, it may be unnecessary in some cases to further encrypt the messages exchanged between devices.

The method 300 begins when the enterprise server 110 decides that the file system (or portion thereof) should be transmitted to the CDN server. This decision may be made, for example, on a periodic basis, at the manual request of an operator of the enterprise server 110, or at the request of another device such as the CDN server 140 or the end user device 120. The enterprise server 110 then generates an encryption key in step 310 according to any appropriate method. Then, in step 320, the enterprise server 320 uses the newly-generated encryption key to encrypt one or more files in step 320 according to an encryption algorithm such as AES or RSA.

After the files have been encrypted, the enterprise server 110 transmits the encrypted files at one or more CDN servers 140 in step 330. In various embodiments step 330 may involve establishing a directory structure on the CDN server 140 such as, for example, a directory structure that mirrors that of the enterprise server 110. As such, the end user device 120 may locate a desired file in the same way regardless of whether the end user 120 device accesses the file from the CDN server 140 or the enterprise server 110 directly.

It will be apparent that the CDN server 140 to which the files are transmitted may not be the same CDN server that is eventually accessed by the end user device 120 to retrieve files; for example, the enterprise server 110 may transmit the encrypted files to a CDN central server which then distributes the encrypted files to one or more CDN file servers to be accessed by end user devices. As another example, in some embodiments any given CDN server 140 may distribute the files to any other CDN server that the end user device 120 requests the files from. In such decentralized design, multiple CDN servers 140 cooperate to store the files and serve end user requests. Similarly, the enterprise server 110 that encrypts the files may not be the same server that stores and provides access to the files within the enterprise VPN; instead, in some embodiments, the enterprise server 110 may retrieve the files to be encrypted and transmitted to the CDN from one or more other enterprise file servers that serve the files within the VPN.

To provide the end user device 120 the ability to decrypt the files stored on the CDN server, the enterprise server 110 transmits the encryption key (or a portion thereof used for decryption operations) to the end user device in step 340. According to various embodiments, the encryption key may be transmitted via a VPN tunnel. Step 340 may be executed at various times such as, for example, immediately after generating the key in step 310, immediately after storing the files in step 330, upon request by the end user device 120, or upon the end user device 120 connecting to the enterprise VPN. Thereafter, the end user device requests and receives one or more files from the CDN server 140 in step 350 and, using the encryption key, decrypt the file for use in step 360.

To further prevent the CDN operator from accessing secret data (e.g., by guessing the encryption key and decrypting the data), the enterprise server 110 may periodically change the encryption key and re-upload the files to the CDN server 140, newly encrypted based on the new key. In other words, the enterprise server 110 may periodically re-perfrom steps 310, 320, 330, and 340. Similarly, with regard to the following examples and other embodiments, the enterprise server 110 may periodically re-perform the data or metadata obscuring techniques described herein and communicate any key data to user devices as appropriate.

In addition to keeping the data itself secret from the CDN operator, the enterprise may also wish to keep various metadata secret. For example, the enterprise may wish to avoid exposing the filenames or directory structure of the file system to the CDN operator. To avoid exposing this metadata, the enterprise may transform the filename of each file to be uploaded to the CDN server. As will be understood, the term “file name” may refer to a fully-qualified file name (e.g., “/usr/username/documents/file.txt”) or a relative file name (e.g. “file.txt”).

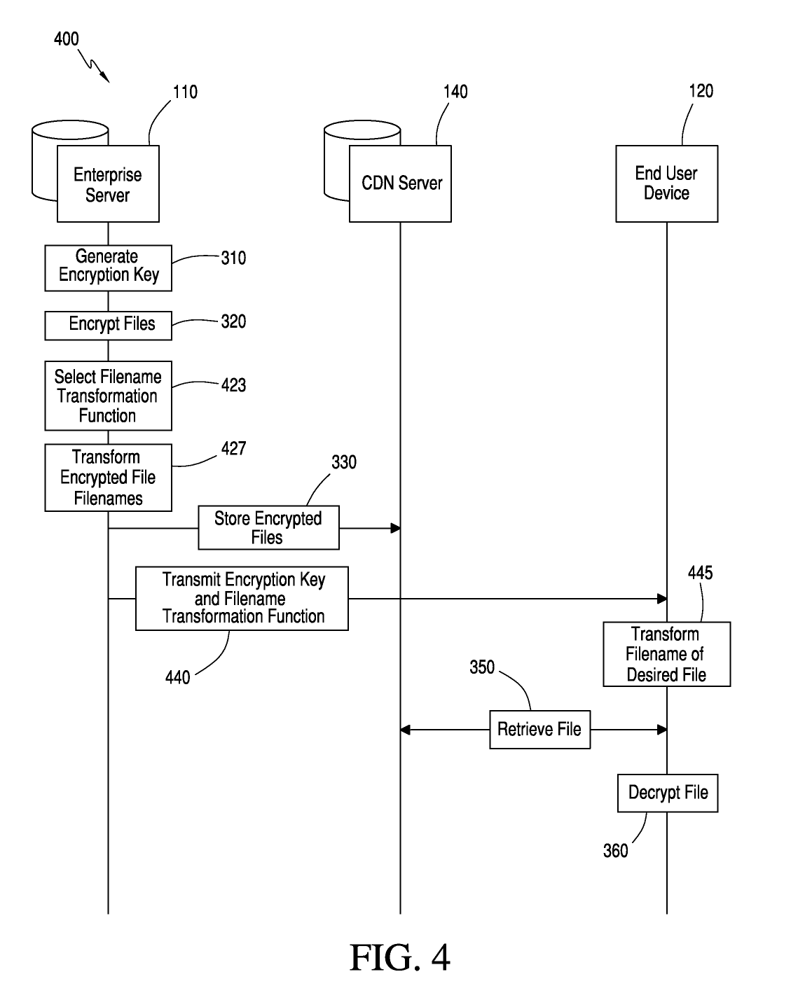

FIG. 4 illustrates a second example method 400 for storing and accessing secure enterprise data on a CDN server. As will be shown, this second example utilizes filename transformation to obscure metadata from the CDN server 140. The method 400 involves three devices: an enterprise server 110, an end user device 120, and a CDN server 140. As with the first example method 300, the method 400 may include additional devices not shown such as, for example, additional CDN servers 140 or a CDN central server for distributing file data among multiple CDN file servers or additional CDN servers 140 all responsible for distributing file data among multiple CDN file servers.

The method 400 includes multiple steps that are similar to those performed in the first example method 300. After the enterprise server 110 encrypts the file data in step 320, instead of immediately transferring the encrypted files to the CDN server 140, the enterprise server 110 first selects a filename transformation function 423. The filename transformation function may be virtually any function that will repeatably transform a string into another string. For example, the transformation function may be a hash function applied to each encrypted file's filename. The hash function may be selected while ensuring that there is no collision between two so-generated filenames. As another example, the transformation function may be a mapping function that utilizes a data structure defining a correspondence between each file name in the file system and an obscured file name. Where the transformation function is to be applied to a fully qualified file name, the transformation function may be applied to the file name as a whole (e.g., “/usr/username/documents/file.txt” may correspond to an obscured filename “0xAF53E67”), applied separately to the file path and relative file name (e.g., “/usr/username/documents/file.txt” may correspond to an obscured filename “0xFE53D1/0xB689CD”), applied separately to each portion of the file name (e.g., “/usr/username/documents/file.txt” may correspond to an obscured filename “/Ox4DD3/0x7596/0x1AA3/0x56EF”), or applied in any other manner sufficient for transforming a file name. Step 423 may include selecting a transformation function from a set of available functions, modifying an existing or template function based on a different seed value (such that the same function can be used to provide different results on each execution of the method 400), generating a new transformation function, generating a new correspondence data structure, or any other method. After selecting the transformation in step 423, the enterprise server 110 uses the function to transform the filename of each encrypted file in step 427. Thereafter, the encrypted files are stored in step 330, as before, but now under the transformed file names.

Method 400 also expands the key information that is transmitted to the end user device. Specifically, at step 440, in addition to information used to decrypt the files, the enterprise server also transfers information necessary to operate within the obscured directory structure. For example, the enterprise server 110 may transmit a transformation function to the end user device by, for example, transmitting the function code itself, transmitting an identification of a transformation function when the available functions (or template functions) are agreed upon a priori, one or more seed values for modifying a template function, etc. The enterprise server 120 may also transmit an overview of the directory structure to enable the end user device 120 to browse the directories locally to locate a desired file (because the CDN server 140 is only able to convey the obscured directory structure or filenames). After the end user device 120 determines a file to request, the end user device applies the transformation function to the clear filename to obtain the obscured filename. Then, the obscured filename may be requested in step 350 and the received file decrypted in step 360.

In various alternative embodiments, instead of providing the transformation function to the end user device, the enterprise server 110 may provide an inverse function of the transformation function such that a transformed filename may be unobscured. Such an arrangement may be possible where the originally-selected transformation function is an invertible function (e.g., a function other than a hash function). In such embodiments, instead of transforming the filename of the desired file in step 445, the end user device may browse obscured file system the CDN server 140, unobscuring the filenames locally for presentation to the user or higher level application.

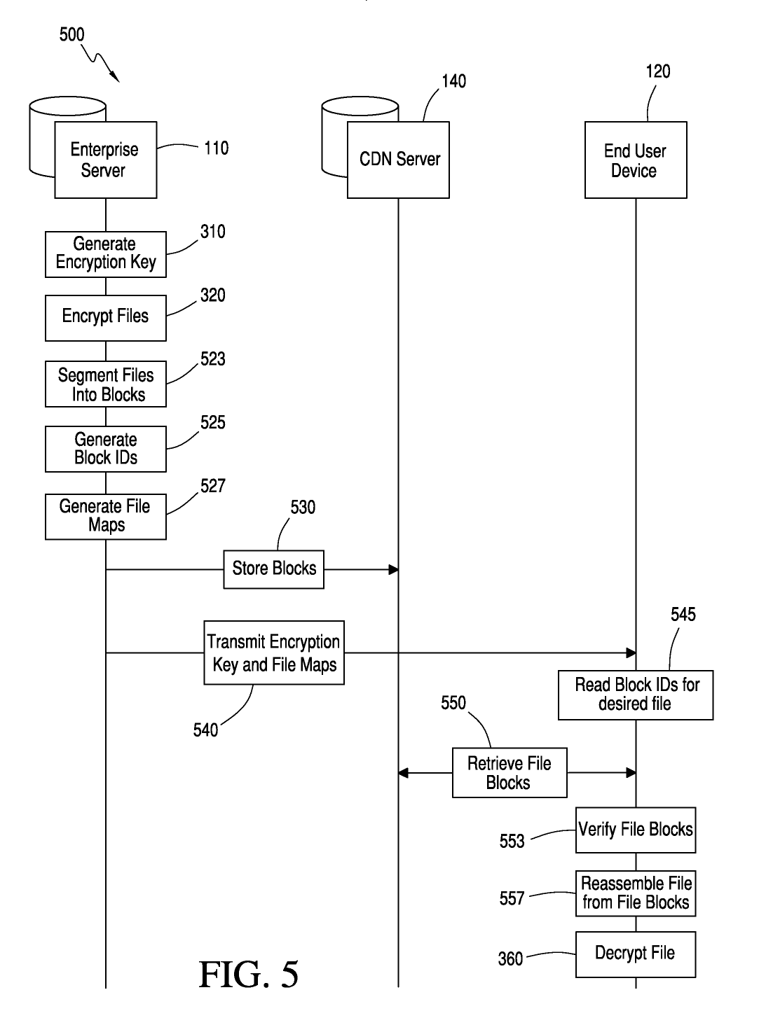

While filename transformation may operate to obscure metadata such as filenames and directory structure, an enterprise may wish to hide additional metadata from the CDN operator such as, for example, file sizes. To provide additional metadata protection, various embodiments may split files into multiple blocks for storage on the CDN server for retrieval and reassembly by a user device. FIG. 5 illustrates a third example method 500 for storing and accessing secure enterprise data on a CDN server. As will be shown, this third example utilizes file segmentation to obscure metadata from the CDN server 140. The method 500 involves three devices: an enterprise server 110, an end user device 120, and a CDN server 140. As with the first example method 300, the method 500 may include additional devices not shown such as, for example, additional CDN servers 140 or a CDN central server for distributing file data among multiple CDN file servers or additional CDN servers 140 all responsible for distributing file data among multiple CDN file servers.

The method 500 includes multiple steps that are similar to those performed in the first example method 300. After the enterprise server 110 encrypts the files in step 320, the enterprise server 110 segments each encrypted file into two or more blocks in step 523. Alternatively, the enterprise server 110 may segment the unencrypted files and encrypt the individual blocks. Next, in step 525, the enterprise server 110 generates block identifiers for each block produced in step 523. These identifiers may be generated in any manner that will produce (or is likely to produce) a unique identifier for each block. For example, in some embodiments step 525 may include generating random numbers or strings for each block while ensuring that there is no collision between two so-generated identifiers. Alternatively, to enable end user devices 110 to verify block integrity, the block identifiers may be generated based on the block data itself. For example, the enterprise server 110 may apply a hash function to an unencrypted block or an encrypted block. It will be appreciated that application of the hash function to the unencrypted block instead of the encrypted block will have the added benefit that the CDN server 140 will not be able to generate the block identifiers itself (and thereby compromise the system even with knowledge of the function used). Virtually any hash function may be used such as, for example, MD5-128, SHA-256, SHA-384, SHA-512, etc.

Next, in step 527, the enterprise server 110 generates file maps for each file that was encrypted. The file maps include, for each file, an identification of the sequence of blocks that, when combined and decrypted, will produce the corresponding file. For example, if the file “file.txt” is split into three blocks having identifiers “0x43,” “0x16,” and “0xE3,” the file map may indicate <file.txt ->0x43,0x16,0xE3>. It will be understood that various arrangements and data structures may be used to convey this information. After generating the file maps, the enterprise server 110 transmits the blocks to the CDN server for storage in step 530 along with the generated block identifiers. In some embodiments, the block identifiers may be included as file names of the individual blocks, such that simple HTTP requests may still be used to retrieve a block from the CDN server 140 based on its block identifier.

Again, the method 500 expands the key information transmitted to the user device 120. In step 540, the enterprise server transmits the encryption key and the file maps generated in step 527 to the user device 120. Thereafter, when the end user device 120 wishes to retrieve a file, it first determines which block identifiers to retrieve using the appropriate file map in step 545. Then the end user device 120 requests and receives one or more blocks from the CDN server 140 in step 550. The user device 120 then verifies the file blocks in step 553 (if the block identifiers were generated to support verification) by using the block data to generate a block identifier in the same manner as in step 525. If the locally generated block identifier matches the requested block identifier, then the block may be taken to be verified. It will be understood that where the block identifiers are generated based on the unencrypted block data, this step will be moved to occur after the blocks are decrypted and the data to be used for verification revealed. If the blocks are verified, the end user device 120 proceeds to reassemble the file based on the sequence identifier by the file map in step 557. Then, the encrypted file may be decrypted in step 360.

Further steps may also be implemented to further defend against a CDN operator from inferring through file storage 530 or access 550 operations which blocks go together to form a file or in what sequence. For example, when storing blocks in step 530, the enterprise server may transmit the blocks in a random order, thereby reducing the possibility that the CDN operator may assume that file blocks transmitted together may belong to the same file. Similarly, the user device 120 may change the order in which blocks are requested in step 550 to prevent the CDN server 140 from learning the sequence of blocks that form a file. The user device 120 may also, in step 550, request additional blocks that are not part of the desired file, thereby reducing the CDN server's ability to identify a requested group of blocks as belonging to the same file. Upon receiving these additional blocks, the user device 120 may simply discard those blocks.

It will be appreciated that various steps may be reordered in alternative implementations. For example, instead of segmenting an encrypted file into encrypted blocks, other implementations may segment the unencrypted file into block which are then subsequently encrypted. In other words, the method 500 may be modified to move step 523 before step 320 and step 360 before step 557. Similarly, in some embodiments, block identifiers may be generated based on unencrypted block data, in which case step 525 may be moved before step 320 and step 553 may be moved after step 360. It will also be apparent that various methods described herein are not mutually exclusive. For example, some embodiments may utilize both file segmentation and filename transformation. Various additional modifications will be apparent.

According to the foregoing, various embodiments enable an enterprise server to make VPN data available on the open Internet, thereby allowing remote users to access data with less network delay. Techniques such as data encryption, file name transformation, and file segmentation facilitate maintaining data and metadata secrecy in spite of the fact that third parties will have access to the data in some form. Various additional advantages will be apparent in view of the foregoing.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A non-transitory machine-readable storage medium encoded with instructions for execution by an enterprise server, the non-transitory machine-readable storage medium comprising:
instructions for providing access to an enterprise file system to end user devices via a virtual private network (VPN);
instructions for encrypting at least a portion of an enterprise file system to produce an encrypted file system, wherein an encrypted file from the encrypted file system is capable of being decrypted using a decryption key;
instructions for transmitting the encrypted file system to a content distribution network (CDN) server for storage and access, wherein the CDN server is located outside the VPN; and
instructions for transmitting the decryption key to an end user device via the VPN.

2. The non-transitory machine-readable storage medium of claim 1, further comprising:
instructions for periodically executing the instructions for encrypting and the instructions for transmitting the encrypted file system, whereby the decryption key changes periodically.

3. The non-transitory machine-readable storage medium of claim 1, further comprising:
instructions for applying a filename transformation to at least one of the enterprise file system and the encrypted file system, wherein at least one file in the encrypted file system has a file name that is different from a file name of a corresponding file in the enterprise file system.

4. The non-transitory machine-readable storage medium of claim 3, further comprising instructions for transmitting an identification of the filename transformation to the end user device via the VPN.

5. The non-transitory machine-readable storage medium of claim 1, further comprising:
instructions for segmenting at least one of a file of the enterprise file system and an encrypted file of the encrypted file system into a plurality of data blocks.

6. The non-transitory machine-readable storage medium of claim 1, wherein the instructions for transmitting the encrypted file system comprise instructions for transmitting a plurality of encrypted data blocks to the CDN server, the non-transitory machine-readable storage medium further comprising:
instructions for generating at least one file map for a file of the encrypted file system, wherein the file map identifies a sequence of blocks from the plurality of encrypted data blocks; and
instructions for transmitting the at least one file map to the end user device via the VPN.

7. The non-transitory machine-readable storage medium of claim 6, wherein the file map identifies a sequence of blocks by specifying a list of block identifiers; and the instructions for encrypting at least a portion of an enterprise file system comprise:
instructions for generating the plurality of encrypted blocks, comprising:
instructions for segmenting at least one file of the enterprise file system into multiple data blocks; and
instructions for generating multiple block identifiers by applying a hash function to the multiple data blocks respectively, whereby the multiple block identifiers are used by a file map to identify the multiple blocks as being associated with the at least one file.

8. An enterprise server comprising:
a network interface capable of communication over an open network and over a virtual private network (VPN);
a memory; and
a processor in communication with the network interface and the memory, the processor configured to:
encrypt at least a portion of an enterprise file system accessible to the enterprise server to produce an encrypted file system, wherein an encrypted file from the encrypted file system is capable of being decrypted using a decryption key;
transmit the encrypted file system to a content distribution network (CDN) server for storage and access, wherein the CDN server is located outside the VPN; and
transmit the decryption key to an end user device via the VPN.

9. The enterprise server of claim 8, wherein the processor is further configured to: periodically perform the steps of encrypting and transmitting the encrypted file system, whereby the decryption key changes periodically.

10. The enterprise server of claim 8, wherein the processor is further configured to:
apply a filename transformation to at least one of the enterprise file system and the encrypted file system, wherein at least one file in the encrypted file system has a file name that is different from a file name of a corresponding file in the enterprise file system.

11. The enterprise server of claim 10, wherein the processor is further configured to transmit an identification of the filename transformation to the end user device via the VPN.

12. The non-enterprise server of claim 8, wherein the processor is further configured to:
segment at least one of a file of the enterprise file system and an encrypted file of the encrypted file system into a plurality of data blocks.

13. The enterprise server of claim 8, wherein, in transmitting the encrypted file system comprise instructions for transmitting a plurality of encrypted data blocks to the CDN server, the processor is configured to:
generate at least one file map for a file of the encrypted file system, wherein the file map identifies a sequence of blocks from the plurality of encrypted data blocks; and
transmit the at least one file map to the end user device via the VPN.

14. The enterprise server of claim 13, wherein the file map identifies a sequence of blocks by specifying a list of block identifiers; and in encrypting at least a portion of an enterprise file system the processor is configured to:
generate the plurality of encrypted blocks, comprising:
segmenting at least one file of the enterprise file system into multiple data blocks; and
generating multiple block identifiers by applying a hash function to the multiple data blocks respectively, whereby the multiple block identifiers are used by a file map to identify the multiple blocks as being associated with the at least one file.

15. A method performed by an enterprise server, the method comprising:
providing access to an enterprise file system to end user devices via a virtual private network (VPN);
encrypting at least a portion of an enterprise file system to produce an encrypted file system, wherein an encrypted file from the encrypted file system is capable of being decrypted using a decryption key;
transmitting the encrypted file system to a content distribution network (CDN) server for storage and access, wherein the CDN server is located outside the VPN; and
transmitting the decryption key to an end user device via the VPN.

16. The method of claim 15, further comprising:
periodically executing the instructions for encrypting and the instructions for transmitting the encrypted file system, whereby the decryption key changes periodically.

17. The method of claim 15, further comprising:
instructions for applying a filename transformation to at least one of the enterprise file system and the encrypted file system, wherein at least one file in the encrypted file system has a file name that is different from a file name of a corresponding file in the enterprise file system.

18. The method of claim 15, further comprising:
segmenting at least one of a file of the enterprise file system and an encrypted file of the encrypted file system into a plurality of data blocks.

19. The method of claim 15, wherein the step of transmitting the encrypted file system comprises transmitting a plurality of encrypted data blocks to the CDN server, the method further comprising:
generating at least one file map for a file of the encrypted file system, wherein the file map identifies a sequence of blocks from the plurality of encrypted data blocks; and
transmitting the at least one file map to the end user device via the VPN.

20. The method of claim 19, wherein the file map identifies a sequence of blocks by specifying a list of block identifiers; and the step encrypting at least a portion of an enterprise file system comprise:
generating the plurality of encrypted blocks, comprising:
segmenting at least one file of the enterprise file system into multiple data blocks; and
generating multiple block identifiers by applying a hash function to the multiple data blocks respectively, whereby the multiple block identifiers are used by a file map to identify the multiple blocks as being associated with the at least one file.
